(19) United States
(12) Patent Application Publication
(10) Pub. No.: US 2025/0358882 A1
(43) Pub. Date: Nov. 20, 2025

(54) ELECTRONIC DEVICE AND METHOD FOR ADAPTIVELY PERFORMING LINK AGGREGATION

(71) Applicant: Samsung Electronics Co., Ltd., Suwon-si (KR)

(72) Inventor: Jusik YUN, Suwon-si (KR)

(21) Appl. No.: 19/288,512

(22) Filed: Aug. 1, 2025

Related U.S. Application Data
(63) Continuation of application No. PCT/KR2024/004456, filed on Apr. 4, 2024.

(30) Foreign Application Priority Data
May 8, 2023 (KR) 10-2023-0059415
May 31, 2023 (KR) 10-2023-0069814

(51) Int. Cl. H04W 76/15; H04W 76/18

(52) U.S. Cl. CPC H04W 76/15; H04W 76/18

(57) ABSTRACT

An electronic device may comprise one or more wireless communication modules comprising communication circuitry configure to transmit and/or receive a wireless signal; at least one processor, comprising processing circuitry, operatively connected to the wireless communication modules; and a memory including instructions, wherein at least one processor, individually and/or collectively, may be configured to execute the instructions and to cause the electronic device to: receive, for links associated through link aggregation, from the wireless communication module, characteristics of data to be transmitted through the links and characteristics of channels used by the links; calculate aggregation gain and aggregation loss based on the characteristics of the data and the characteristics of the channels; and cause the wireless communication module to adaptively trigger multi-link aggregation of the links based on a comparison result of the aggregation gain and the aggregation loss.

### CROSS-REFERENCE TO RELATED APPLICATIONS

This application is a continuation of International Application No. PCT/KR2024/004456 designating the United States, filed on Apr. 4, 2024, in the Korean Intellectual Property Receiving Office and claiming priority to Korean Patent Application Nos. 10-2023-0059415, filed on May 8, 2023, and 10-2023-0069814, filed on May 31, 2023, in the Korean Intellectual Property Receiving Office, the disclosures of each of which are incorporated by reference herein in their entireties.

### BACKGROUND

### Field

The disclosure relates to an electronic device for adaptively performing link aggregation.

### Description of Related Art

With the advent of electronic devices, such as a smartphone, a tablet personal computer (PC), or a laptop, the demand for high-speed wireless connectivity has exploded. Driven by these trends and the growing demand for high-speed wireless connectivity, the Institute of Electrical and Electronics Engineers (IEEE) 802.11 wireless communication standard is firmly established as a representative and universal high-speed wireless communication standard in the information technology (IT) industry. Early wireless local area network (LAN) technologies developed around 1997 could support transmission speeds of up to 1 to 2 megabits per second (Mbps). Since then, based on the demand for faster wireless connectivity, wireless LAN technologies have steadily developed, including new wireless LAN technologies that improve transmission speeds, such as IEEE 802.11n, 802.11ac, and 802.11ax. The current latest standard, IEEE 802.11 ax, has a maximum transmission speed of several gigabits per second (Gbps).

Wireless LANs provide high-speed wireless connections to users in various public places, such as offices, airports, stadiums, and stations, in addition to private places such as homes. Accordingly, wireless LAN has greatly influenced people's lifestyles and culture and has become a lifestyle in modern life.

### SUMMARY

An electronic device according to an example embodiment may include: one or more wireless communication modules comprising communication circuitry configured to transmit and receive a wireless signal; at least one processor, comprising processing circuitry, operatively connected to the wireless communication modules; a memory including instructions, wherein at least one processor, individually or collectively, may be configured to execute the instructions and to cause the electronic device to: for links associated through link aggregation, receive, from the wireless communication modules, characteristics of pieces of data to be transmitted through the links and characteristics of channels used by the links; calculate aggregation gain and aggregation loss based on the characteristics of the pieces of data and the characteristics of the channels; and cause the wireless communication modules to adaptively trigger link aggregation of the links based on a comparison result of the aggregation gain and the aggregation loss.

A method of operating an electronic device according to an example embodiment may include: receiving, for links associated through link aggregation, characteristics of pieces of data to be transmitted through the links and characteristics of channels used by the links; calculating aggregation gain and aggregation loss based on the characteristics of the pieces of data and the characteristics of the channels; and adaptively triggering multi-link aggregation of the links based on a comparison result of the aggregation gain and the aggregation loss.

An electronic device according to an example embodiment may include: one or more wireless communication modules comprising communication circuitry configured to transmit and receive a wireless signal; at least one processor, comprising processing circuitry, operatively connected to the wireless communication modules; a memory including instructions, wherein at least one processor, individually or collectively, may be configured to execute the instructions and to cause the electronic device to: for aggregated links through link aggregation, receive, from the wireless communication modules, characteristics of pieces of data to be transmitted through the aggregated links and characteristics of channels used by the aggregated links; and cause the wireless communication modules to selectively terminate link aggregation of the aggregated links based on at least one of the characteristics of the pieces of data or the characteristics of the channels.

A method of operating an electronic device according to an example embodiment may include: receiving, for aggregated links through link aggregation, characteristics of pieces of data to be transmitted through the aggregated links and characteristics of channels used by the aggregated links; and selectively terminating link aggregation of the aggregated links based on at least one of the characteristics of the pieces of data or the characteristics of the channels.

An electronic device according to an example embodiment may include: one or more wireless communication modules comprising communication circuitry configured to transmit and receive a wireless signal; at least one processor, comprising processing circuitry, operatively connected to the wireless communication modules; a memory including instructions, wherein at least one processor, individually or collectively, may be configured to execute the instructions and to cause the electronic device to: receive, for links associated through link aggregation, from the wireless communication modules, characteristics of pieces of data to be transmitted through the links and characteristics of channels used by the links; and adaptively trigger multi-link aggregation of the links based on the characteristics of the pieces of data and the characteristics of the channels, wherein the characteristics of the pieces of data may include quality of service (QoS) requirements of a service executed through the electronic device, which are obtained based on a traffic specification (TSPEC) element.

A method of operating an electronic device according to an example embodiment may include: receiving, for links associated through link aggregation, characteristics of pieces of data to be transmitted through the links and characteristics of channels used by the links; and adaptively triggering multi-link aggregation of the links based on the characteristics of the pieces of data and the characteristics of the channels, wherein the characteristics of the pieces of data may include QoS requirements of a service executed through the electronic device, which are obtained based on a TSPEC element.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIGS. 1 and 2 are diagrams illustrating an example wireless local area network (WLAN) system according to various embodiments;

FIG. 3 is a diagram illustrating an example multi-link device (MLD) according to various embodiments;

FIG. 4 is a diagram illustrating an example multi-link operation (MLO) according to various embodiments;

FIG. 5 is a diagram illustrating example interference between antennas;

FIG. 6 is a diagram illustrating an example non-simultaneous transmit and receive operation (NSTR) mode of an MLD, according to various embodiments;

FIG. 7 is a diagram illustrating example link aggregation;

FIG. 8 is a block diagram illustrating an example configuration of a non-access point (AP) MLD according to various embodiments;

FIGS. 9 and 10 are diagrams illustrating an example operation of triggering link aggregation based on aggregation gain and aggregation loss, according to various embodiments;

FIG. 11 is a diagram illustrating an example operation of triggering link aggregation based on the characteristics of pieces of data and the characteristics of channels, according to various embodiments;

FIG. 12 is a diagram illustrating an example operation of selectively terminating link aggregation according to various embodiments;

FIG. 13 is a diagram illustrating an example traffic specification (TSPEC) element according to various embodiments;

FIGS. 14, 15 and 16 are flowcharts illustrating methods of operating an electronic device, according to various embodiments; and

FIG. 17 is a block diagram illustrating an example electronic device in a network environment, according to various embodiments.

### DETAILED DESCRIPTION

Hereinafter, various example embodiments will be described in greater detail with reference to the accompanying drawings. When describing the example embodiments with reference to the accompanying drawings, like reference numerals refer to like elements and a repeated description related thereto may not be provided.

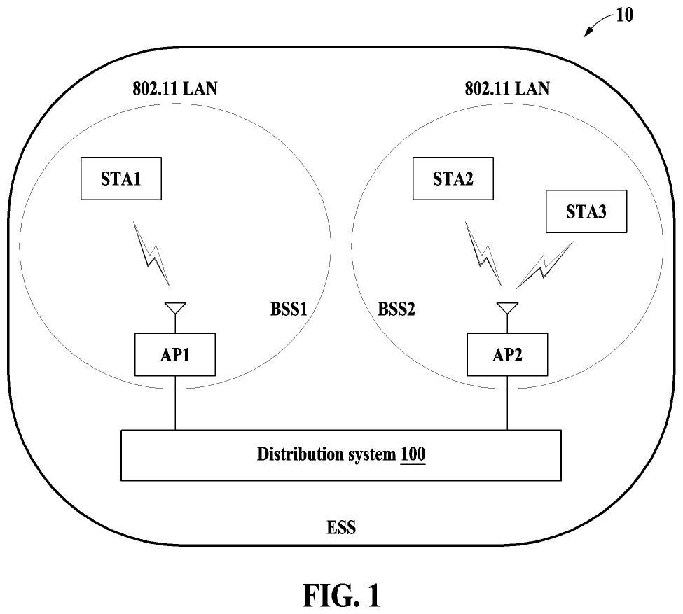

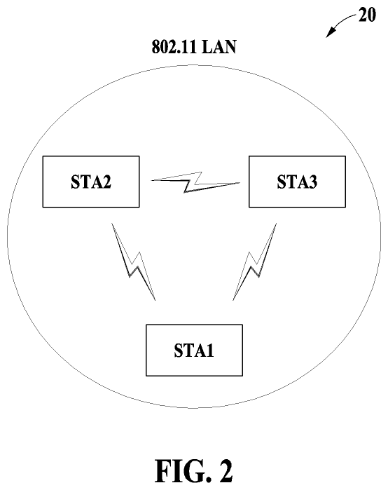

FIGS. 1 and 2 are diagrams illustrating an example wireless local area network (WLAN) system according to various embodiments.

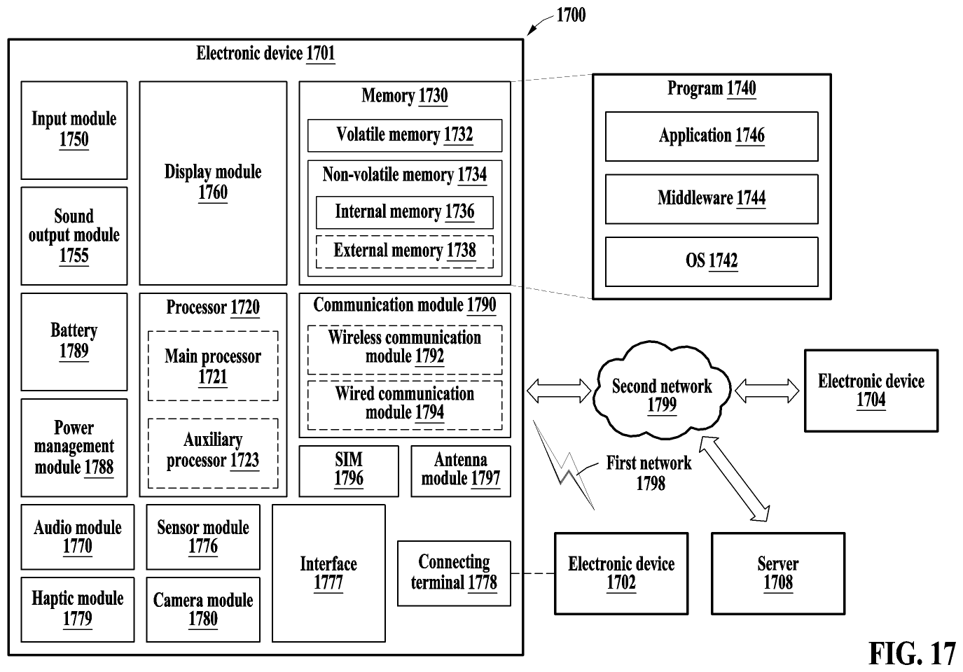

Referring to FIG. 1, according to an embodiment, a WLAN system 10 may be an infrastructure mode in which an access point (AP) is present in a structure of a WLAN of the Institute of Electrical and Electronic Engineers (IEEE) 802.11 standard. The WLAN system 10 may include one or more basic service sets (BSSs) (e.g., BSS1 and BSS2). The BSS (e.g., BSS1 or BSS2) may refer to a set of APs and stations (STAs) (e.g., an electronic device 1702 and an electronic device 1704 of FIG. 17) that may communicate with each other with a successful synchronization. The BSS1 may include an AP1 and an STA1, and the BSS2 may include an AP2, an STA2, and an STA3.

According to an embodiment, the WLAN system 10 may include at least one STA (e.g., STA1 to STA3), a plurality of APs (e.g., AP1 and AP2) providing a distribution service, and a distribution system 100 connecting the plurality of APs (e.g., AP1 and AP2). The distribution system 100 may implement an extended service set (ESS), which is a service set extended by connecting a plurality of BSSs (e.g., BSS1 and BSS2). The ESS may be used as a term referring to one network in which the plurality of APs (e.g., AP1 and AP2) are connected through the distribution system 100. The plurality of APs (e.g., AP1 and AP2) included in one ESS may have the same service set identification (SSID).

According to an embodiment, the STA (e.g., STA1 to STA3) may be an arbitrary functional medium including a medium access control (MAC) and a physical layer interface for a wireless medium that conform to the provisions of the IEEE 802.11 standard. The term “STA” (e.g., STA1 to STA3) may be used to collectively refer to both an AP and a non-AP STA. The STA (e.g., STA1 to STA3) may also be referred to by various names, such as an electronic device, a mobile terminal, a wireless device, a wireless transmit/receive unit (WTRU), user equipment (UE), a mobile station (MS), a mobile subscriber unit, or simply, a user.

Referring to FIG. 2, according to an embodiment, a WLAN system 20 may represent an ad-hoc mode in which a network is established and communicated between a plurality of STAs (e.g., STA1 to STA3) without any AP in the structure of a WLAN of the IEEE 802.11 standard, as opposed to the WLAN system 10 of FIG. 1. The WLAN system 20 may include a BSS operating in an ad-hoc mode, for example, an independent IBSS.

According to an embodiment, the IBSS does not include any AP, and therefore, it may not include a centralized management entity that performs a central management function. In the IBSS, the STAs may be managed in a distributed manner. In the IBSS, all the STAs may be mobile STAs and may form a self-contained network (or an integrated network) because access to a distribution system is not allowed.

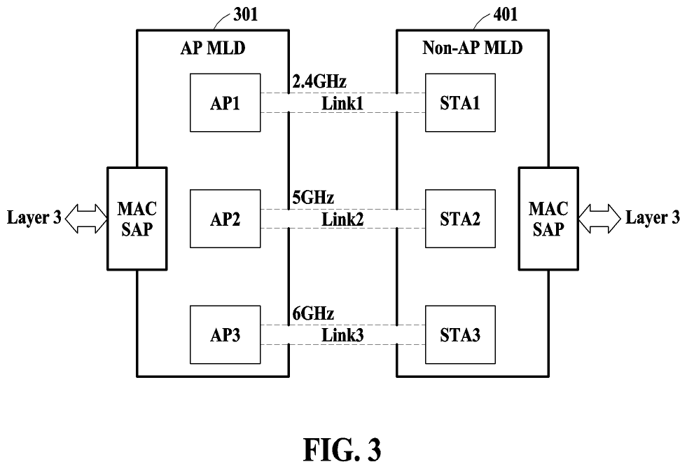

FIG. 3 is a diagram illustrating an example multi-link device (MLD) according to various embodiments.

Referring to FIG. 3, according to an embodiment, an AP MLD 301 and a non-AP MLD 401 may perform a multi-link operation (MLO) that communicates using a plurality of individual links (e.g., link 1, link 2, and link 3). The AP MLD 301 may be a device including one or more APs (e.g., AP1, AP2, and AP3). The AP MLD 301 may be a device connected to a logical link control (LLC) layer through one interface (e.g., a MAC service access point (SAP)). The one or more APs (e.g., AP1, AP2, and AP3) included in the AP MLD 301 may share some functions in the MAC layer. The APs in the AP MLD 301 may operate in different links (e.g., AP1 operates through link 1, AP2 operates through link 2, and AP3 operates through link 3). Each of the APs (e.g., AP1, AP2, and AP3) in the AP MLD 301 may be in charge of a corresponding link, respectively, and may perform the role of an independent AP.

According to an embodiment, the non-AP MLD 401 may be a device including one or more non-APs (e.g., STA1, STA2, and STA3). The non-AP MLD 401 may be a device connected to an LLC layer through one interface (e.g., a MAC SAP). The one or more non-APs (e.g., STA1, STA2, and STA3) included in the non-AP MLD 401 may share some functions in the MAC layer. The STAs in the non-AP MLD 401 may operate in different links (e.g., STA1 operates through link 1, STA2 operates through link 2, and STA3 operates through link 3). Each of the STAs (e.g., STA1, STA2, and STA3) in the non-AP MLD 401 may be in charge of a corresponding link, respectively, and may perform the role of an independent STA. The non-AP MLD may also be expressed as an STA MLD.

According to an embodiment, when the AP MLD 301 includes a plurality of APs (e.g., AP1, AP2, and AP3), each of the APs (e.g., AP1, AP2, and AP3) may form a separate link (e.g., link 1, link 2, and link 3) and perform a frame transmission and reception operation using a plurality of links with each of the STAs (e.g., STA1, STA2, and STA3) included in the non-AP MLD 401. The links may utilize a predetermined channel (or bandwidth). For example, each link may operate in the 2.4 gigahertz (GHz), 5 GHz, or 6 GHz band.

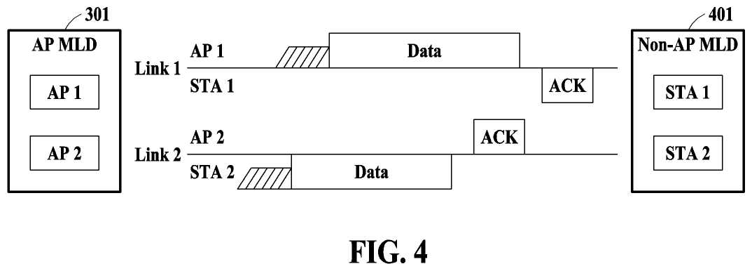

FIG. 4 is a diagram illustrating an example MLO according to various embodiments.

Referring to FIG. 4, according to an embodiment, a schematic diagram illustrating communication (e.g., an MLO) between the AP MLD 301 and the non-AP MLD 401 may be identified. The AP MLD 301 and/or the non-AP MLD 401 may transmit uplink data or downlink data through the MLO. The AP MLD 301 may communicate with the non-AP MLD 401 through a plurality of links (e.g., link 1 and link 2). STA 1 of the non-AP MLD 401 may communicate with AP 1 of the AP MLD 301 through link 1. STA 1 of the non-AP MLD 401 may receive data from AP 1 of the AP MLD 301 through link 1. Link 1 may be a downlink. STA 2 of the non-AP MLD 401 may communicate with AP 2 of the AP MLD 301 through link 2. STA 2 of the non-AP MLD 401 may transmit data to AP 2 of the AP MLD 301 through link 2. Link 2 may be an uplink.

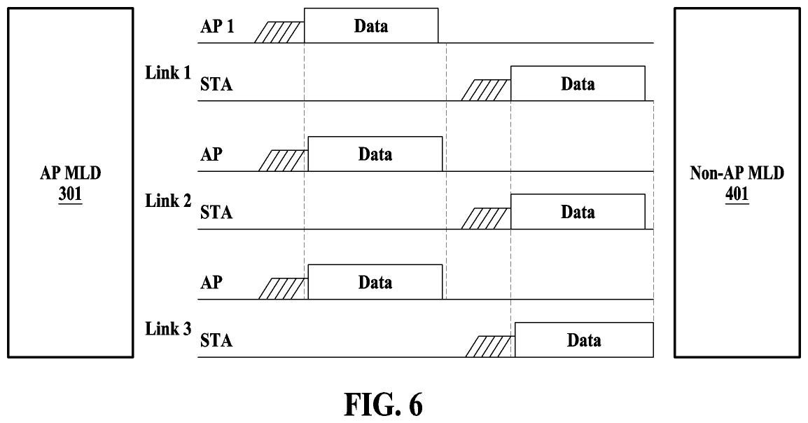

According to an embodiment, a mode (e.g., an operation mode) of the MLO may be divided into a simultaneous transmit and receive operation (STR) mode and a non-STR (NSTR) mode. The STR mode may be an ideal mode that performs individual simultaneous transmission and reception of links. The NSTR mode may be a mode used when individual simultaneous transmission and reception of links is not possible. FIG. 4 is an example of an operation in the STR mode, and FIG. 6 is an example of an operation in the NSTR mode.

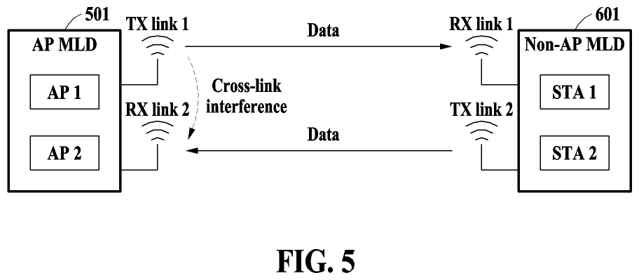

FIG. 5 is a diagram illustrating example interference between antennas.

Referring to FIG. 5, interference between antennas (e.g., in-device coexistence (IDC) interference) may be identified. An STR mode may be utilized in a situation in which a separation distance (e.g., a physical distance) between the antennas is sufficient. When the separation distance between the antennas is sufficient, interference between the antennas (e.g., interference between transmit (TX) link 1 and receive (RX) link 2 of an AP MLD 501 or interference between RX link 1 and TX link 2 of a non-AP MLD 601) may be ignored. Accordingly, when the separation distance between the antennas is sufficient, the transmission power of a link that is transmitting data may not affect another link that is receiving data (or scheduled to receive data). When interference between the antennas does not exist (or is ignorable), the STR mode that performs individual simultaneous transmission and reception may be utilized.

When interference between the antennas is not ignorable, during data transmission of one link (e.g., TX link 1 of the AP MLD 501), the other link (e.g., RX link 2 of the AP MLD 501) may not receive data smoothly. When an antenna of TX link 1 of the AP MLD 501 and an antenna of RX link 2 of the AP MLD 501 exist in an area of mutual interference (e.g., are physically close to each other), RX link 2 of the AP MLD 501 may not receive data smoothly.

The disadvantages of interference between the antennas are not limited to data transmission. Carrier sense multiple access/collision avoidance (CSMA/CA), which is one of the basic processes of wireless fidelity (Wi-Fi), may be performed on each link of the MLD. For the CSMA/CA process, each antenna in charge of a link may sense a carrier, check that a medium is in an idle state, and perform medium access. However, when the antennas exist in an area of mutual interference, the CSMA/CA process of the antennas may also be interfered with. That is, when data is being transmitted through one link (e.g., link 1), CSMA/CA of the other link (e.g., link 2) may be inevitably performed after all transmissions of the corresponding link are terminated.

When one link (e.g., link 1) is transmitting data, and at the same time a back-off counter of the other link (link 2) expires and data transmission is desired to be initiated, the lagged link (e.g., link 2) may perform channel access only after all tasks of the link (e.g., link 1) that is transmitting data are completed. In a situation in which the transmissions of each link overlap as described above, since the lagged link (e.g., link 2) has to wait until data transmission of the leading link (e.g., link 1) is completed, the advantage of multi-link may not be obtained when interference between the antennas exists. To address this problem, an NSTR mode considering interference between the antennas may be used.

FIG. 6 is a diagram illustrating an example NSTR mode of an MLD, according to various embodiments.

Referring to FIG. 6, according to an embodiment, the AP MLD 301 and the non-AP MLD 401 may synchronize at least one of the data transmission start time and/or data transmission end time of links in the NSTR mode.

According to an embodiment, that is, link aggregation may be applied to the NSTR mode. Link aggregation may be a technique that uses a plurality of links as a single logical link to maximize and/or improve the efficiency and utilization of a multi-link. Link aggregation may be utilized in the NSTR mode among the STR mode and the NSTR of Wi-Fi 7. The AP MLD 301 and the non-AP MLD 401 may be free from IDC interference by performing the transmission and reception of aggregated links through synchronization.

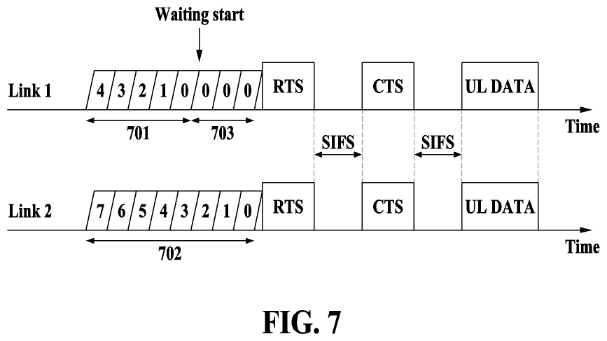

FIG. 7 is a diagram illustrating example link aggregation.

Referring to FIG. 7, according to an embodiment, an operation of aggregated links (e.g., link 1 and link 2) may be identified. Link 1 may be a leading link, and link 2 may be a lagged link. A back-off counter 701 of link 1 may be smaller than a back-off counter 702 of link 2. Link 1 may be a link that is scheduled to access a channel first. It should be noted that link 1 and link 2 utilize different channels (e.g., frequency bands).

According to an embodiment, link 1 and link 2 have the back-off counters 701 and 702 having sizes of 4 and 7, respectively, so link 1 may access the channel first. However, when IDC interference exists between link 1 and link 2, link 2 may experience reception quality degradation as soon as link 1 starts transmitting. Accordingly, the two link-aggregated links may synchronize the data transmission start times in the NSTR mode.

According to an embodiment, the aggregated link, link 1, may start waiting (e.g., start counting an additional back-off counter 703) at the time when the back-off counter 701 expires. Link 1 and link 2 may start data transmission simultaneously at the time when the additional back-off counter 703 and the back-off counter 702 expire.

However, there may still be areas where link aggregation in the synchronization manner needs improvement. There may be no guarantee that channel access of both link 1 and link 2 is successful. When link 1 waits for the additional back-off counter 703, but either link 1 or link 2 fails to access a channel, which may indicate wasting as much as the additional back-off counter 703. This waste of time may seriously degrade the utilization of the channel from a radio resource perspective. Accordingly, depending on the situation, it may be desirable not to use the additional back-off counter 703 (e.g., not to utilize link aggregation). That is, it may be appropriate to utilize link aggregation adaptively depending on the channel situations or the nature of a service being executed.

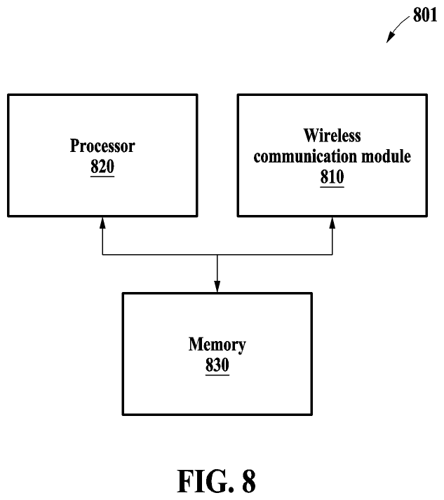

FIG. 8 is a block diagram illustrating an example configuration of an AP MLD according to various embodiments.

According to an embodiment, an electronic device 801 (e.g., the non-AP MLD 401 of FIG. 3) may perform an MLO. The electronic device 801 may adaptively operate link aggregation in the NSTR mode. The electronic device 801 may adaptively operate link aggregation based on the situations of channels used by links and/or data to be transmitted through the links.

Referring to FIG. 8, according to an embodiment, the electronic device 801 may include a wireless communication module (e.g., including wireless communication circuitry) 810 (e.g., a wireless communication module 1792 of FIG. 17), one or more processors (e.g., including processing circuitry) 820 (e.g., a processor 1720 of FIG. 17), and a memory 830 (e.g., a memory 1730 of FIG. 17). The wireless communication module 810 may be configured to transmit and receive a wireless signal. The wireless communication module 810 may be a Wi-Fi chipset. The wireless communication module 810 may support multiple bands of 2.4 GHZ, 5 GHZ, and/or 6 GHZ. The processor 820 may be operatively connected to the wireless communication module 810. The memory 830 may be electrically connected to the processor 820 and may store instructions executable by the processor 820. The electronic device 801 may correspond to an electronic device (e.g., an electronic device 1701 of FIG. 17) to be described with reference to FIG. 17. Therefore, a duplicate description of such described in FIG. 17 is omitted.

According to an embodiment, the processor 820 may include various processing circuitry and be implemented as a system-on-chip (SoC) or circuitry (e.g., processing circuitry) such as an integrated circuit (IC). The processor 820 may include one or more processors. For example, the processor 820 may include a combination of one or more processors, such as a central processing unit (CPU), a graphics processing unit (GPU), a micro processing unit (MPU), an application processor (AP), and a communication processor (CP). Thus, the processor 820 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the memory 830 may include one or more memories. The instructions stored in the memory 830 may be stored in one memory. The instructions stored in the memory 830 may be divided and stored in a plurality of The instructions stored in the memory 830 may be individually or memories. collectively executed by the processor 820 to cause the electronic device 801 to adaptively perform link aggregation according to an embodiment to be described below.

According to an embodiment, the electronic device 801 may be a device that may perform an MLO. The electronic device 801 may utilize the characteristics of pieces of data to be transmitted through the links and the characteristics of channels used by the links.

According to an embodiment, the characteristics of the pieces of data may include the sizes of the pieces of data. The characteristics of the pieces of data may include quality of service (QoS) requirements of a service executed through the electronic device 801. The characteristics of the pieces of data may include an access category that specifies the priority of traffic.

According to an embodiment, the characteristics of the channels may include channel congestion (e.g., channel congestion based on a probability of channel access success). The characteristics of the channels may include the number of channel access failures of aggregated links.

According to an embodiment, the electronic device 801 may maximize and/or improve the efficiency and utilization of a multi-link by adaptively operating link aggregation in the NSTR mode based on the characteristics of the pieces of data and the characteristics of the channels. The electronic device 801 may reduce wasted time (e.g., latency) and efficiently utilize radio resources while preventing/reducing IDC interference.

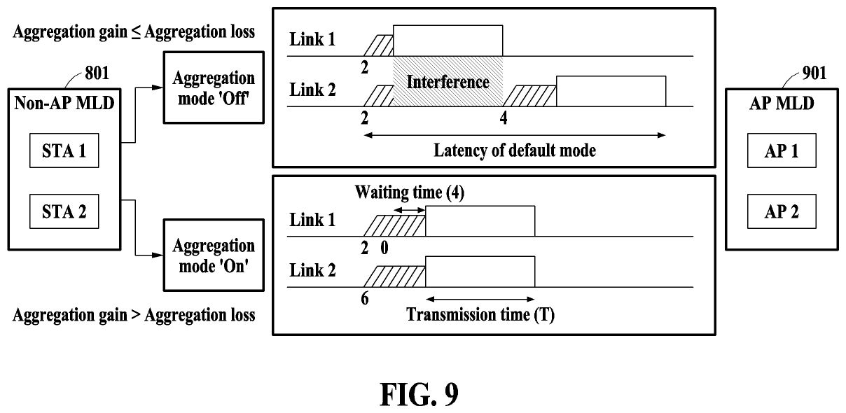

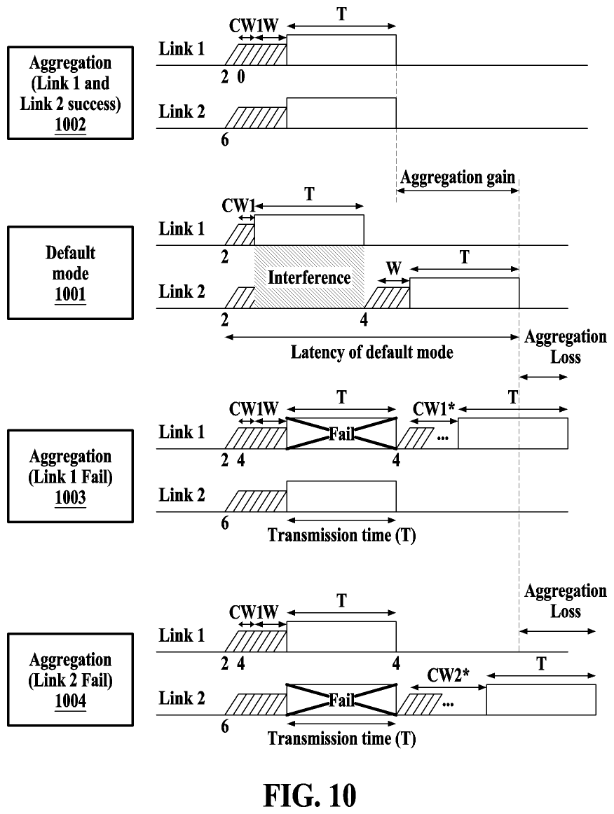

FIGS. 9 and 10 are diagrams illustrating an example operation of triggering link aggregation based on aggregation gain and aggregation loss, according to various embodiments.

Referring to FIG. 9, according to an embodiment, a non-AP MLD 801 (e.g., the non-AP MLD 401 of FIG. 3) (e.g., an electronic device) may trigger link aggregation (e.g., link aggregation of link 1 and link 2) based on the aggregation gain and the aggregation loss. The non-AP MLD 801 may trigger link aggregation when the aggregation gain is greater than the aggregation loss.

Referring to FIG. 10, according to an embodiment, the non-AP MLD 801 may calculate the aggregation gain and the aggregation loss. The aggregation gain and the aggregation loss may be calculated based on the characteristics of pieces of data (e.g., the sizes of the pieces of data) and the characteristics of channels (e.g., a probability of channel access success of links). The aggregation gain and the aggregation loss may be calculated based on latency that changes depending on the channel access success and/or failure of the links (e.g., link 1 and link 2). Latency may correspond to the time required for a data packet to be transmitted from a departure point to a destination through a wireless network.

According to an embodiment, the non-AP MLD 801 may calculate the aggregation gain and the aggregation loss based on four scenarios. The four scenarios may include a first scenario 1001 (e.g., a default mode) in which communication is performed in a state in which link aggregation is deactivated. The four scenarios may include a second scenario 1002 in which the links (e.g., link 1 and link 2) successfully perform channel access at one time in a state in which link aggregation is activated. The four scenarios may include a third scenario 1003 in which link 1 fails channel access one time in a state in which link aggregation is activated. The four scenarios may include a fourth scenario 1004 in which link 2 fails channel access one time in a state in which link aggregation is activated.

According to an embodiment, latency (e.g., Latency_A) in the first scenario 1001 (e.g., a default mode) may be calculated through Equation 1.

$$Latency\_A = CW 1 + T + W + T = C W 1 + W + 2 T \qquad [ Equation l ]$$

In Equation 1, CW1 denotes a back-off counter value of link 1, T denotes a transmission time of link 1 (and a transmission time of link 2) (e.g., a transmission opportunity (TXOP) time), and W denotes a value (e.g., a remaining back-off counter value of link 2) obtained by subtracting the back-off counter value of link 1 from a back-off counter value of link 2. Although data transmission rates are different for each link, the non-AP MLD 801 operating in an NSTR mode may pre-schedule a physical layer convergence procedure protocol data unit (PPDU) so that the transmission time of link 1 and the transmission time of link 2 are substantially the same.

According to an embodiment, a back-off counter of link 1 and a back-off counter of link 2 may be deducted simultaneously (e.g., during CW1). When the back-off counter of link 1 expires, the non-AP MLD 801 with link aggregation deactivated may transmit data through link 1 (e.g., during T). When data transmission through link 1 is completed, the remaining back-off counter of link 2 may be deducted (e.g., during W). When the back-off counter of link 2 expires, the non-AP MLD 801 may transmit data through link 2 (e.g., during T). Latency (e.g., Latency_A) in the first scenario 1001 (e.g., a default mode) may be a total of CW1+W+2T.

According to an embodiment, latency (e.g., Latency_B) in the second scenario 1002 may be calculated through Equation 2.

$$Latency\_B = CW 1 + W + T \qquad [ Equation 2 ]$$

In Equation 2, CW1 denotes a back-off counter value of link 1, W denotes a value (e.g., an additional back-off counter value of link 1) obtained by subtracting the back-off counter value of link 1 from a back-off counter value of link 2, and T denotes a transmission time of link 1 (and a transmission time of link 2).

According to an embodiment, a back-off counter of link 1 and a back-off counter of link 2 may be deducted simultaneously (e.g., during CW1). When the back-off counter of link 1 expires, the non-AP MLD 801 with link aggregation activated may generate an additional back-off counter of link 1 and deduct the additional back-off counter of link 1 and the remaining back-off counter of link 2 (e.g., during W). When the additional back-off counter of link 1 expires (e.g., when the back-off counter of link 2 expires), the non-AP MLD 801 may simultaneously transmit data through link 1 and link 2 (e.g., during T). Latency (e.g., Latency_B) in the second scenario 1002 may be a total of CW1+W+T.

According to an embodiment, latency (e.g., Latency_C) in the third scenario 1003 may be calculated through Equation 3.

$$Latency\_C = CW 1 + W + T + C W {1}^{*} + T \qquad [ Equation 3 ]$$

In Equation 3, CW1 denotes a back-off counter value of link 1, W denotes a value (e.g., an additional back-off counter value of link 1) obtained by subtracting the back-off counter value of link 1 from a back-off counter value of link 2, T denotes a transmission time of link 2 (and a transmission time of link 1), and CW1* denotes a back-off counter value that is reset according to the channel access failure of link 1.

According to an embodiment, a back-off counter of link 1 and a back-off counter of link 2 may be deducted simultaneously (e.g., during CW1). When the back-off counter of link 1 expires, the non-AP MLD 801 with link aggregation activated may generate an additional back-off counter of link 1 and deduct the additional back-off counter of link 1 and the remaining back-off counter of link 2 (e.g., during W). When the additional back-off counter of link 1 expires (e.g., when the back-off counter of link 2 expires), the non-AP MLD 801 may attempt channel access through link 1 and link 2. When channel access of link 1 fails and only channel access of link 2 succeeds, the non-AP MLD 801 may transmit data through link 2 (e.g., during T). When data transmission of link 2 is completed, the non-AP MLD 801 may deduct a back-off counter that is reset according to the channel access failure of link 1 (e.g., during CW1*) again. When the reset back-off counter of link 1 expires, the non-AP MLD 801 may transmit data through link 1 (e.g., during T). Latency (e.g., Latency_C) in the third scenario 1003 may be a total CW1+W+2T+CW11*.

According to an embodiment, latency (e.g., Latency_D) in the fourth scenario 1004 may be calculated through Equation 4.

$$Latency\_D = CW 1 + W + T + C W {2}^{*} + T \qquad [ Equation 4 ]$$

In Equation 4, CW1 denotes a back-off counter value of link 1, W denotes a value (e.g., an additional back-off counter value of link 1) obtained by subtracting the back-off counter value of link 1 from a back-off counter value of link 2, T denotes a transmission time of link 1 (and a transmission time of link 2), and CW2* denotes a back-off counter value that is reset according to the channel access failure of link 2.

According to an embodiment, a back-off counter of link 1 and a back-off counter of link 2 may be deducted simultaneously (e.g., during CW1). When the back-off counter of link 1 expires, the non-AP MLD 801 with link aggregation activated may generate an additional back-off counter of link 1 and deduct the additional back-off counter of link 1 and the remaining back-off counter of link 2 (e.g., during W). When the additional back-off counter of link 1 expires (e.g., when the back-off counter of link 2 expires), the non-AP MLD 801 may attempt channel access through link 1 and link 2. When channel access of link 2 fails and only channel access of link 1 succeeds, the non-AP MLD 801 may transmit data through link 1 (e.g., during T). When data transmission of link 1 is completed, the non-AP MLD 801 may deduct a back-off counter that is reset according to the channel access failure of link 2 (e.g., during CW2*). When the reset back-off counter of link 2 expires, the non-AP MLD 801 may transmit data through link 2 (e.g., during T). Latency (e.g., Latency_D) in the fourth scenario 1004 may be a total of CW1+W+2T+CW2*.

According to an embodiment, the aggregation gain may be a decrease in latency obtained through successful channel access of the links at one time. The aggregation gain (e.g., AG_{gain}) may be calculated through Equation 5.

$$AG\_gain = ( Latency\_A - {latency}_{-} B ) * ( P 1 * P 2 ) = T ( P 1 * P 2 ) \qquad [ Equation 5 ]$$

In Equation 5, latency_A denotes latency in the first scenario 1001, Latency_B denotes latency in the second scenario 1002, P1 denotes a probability of channel access success of link 1, P2 denotes a probability of channel access success of link 2, and T denotes a transmission time of link 1 and link 2.

According to an embodiment, the probability of channel access success may be calculated based on channel information that is obtainable from the Android open source project (AOSP). For example, the probability of channel access success P_{succ} based on the information that is obtainable from the AOSP may be calculated through Equation 6.

$${P}_{succ} = \frac{{T}_{on} - {T}_{CCA}}{{T}_{on}} \qquad [ Equation 6 ]$$

In Equation 6, a probability of channel access success Tₒₙ denotes the total time that a radio is on RadioOnTime and T_{CCA} denotes a busy time CCABusyTime.

According to an embodiment, the probability of channel access success may be calculated through a channel utilization (CU) value provided by an AP (e.g., the AP MLD 301 of FIG. 3 and an AP MLD 901 of FIG. 9). The CU value may be verified through Equation 7, and the probability of channel access success P_{succ} based on the CU value may be calculated through Equation 8.

$$⌊ \frac{channel busy time}{dotI 1 ChannelUtilizationBeaconIntervals \times dotI 1 BeaconPeriod \times 1024} \times 255 ⌋ \qquad [ Equation 7 ]$$

$${P}_{succ} = \frac{255 - CU}{255} \qquad [ Equation 8 ]$$

According to an embodiment, the aggregation loss may be an increase in latency obtained by failing channel access of the links at least one time. The aggregation loss (e.g., AGₗₒₛₛ) may be calculated through Equation 9.

$$AG\_loss = ( 1 - P 1 ) ( P 2 * P 1 ) ( Latency\_C - Latency\_A ) + ( 1 - P 2 ) ( P 1 * P 2 ) ( Latency\_D - LatencyA ) + alpha = ( 1 - P 1 ) ( P 2 * P 1 ) ( CW {1}^{*} ) + ( 1 - P 2 ) ( P 1 * P 2 ) ( CW {2}^{*} ) + alpha \qquad [ Equation 9 ]$$

In Equation 9, P1 denotes a probability of channel access success of link 1, P2 denotes a probability of channel access success of link 2, latency_C denotes latency in the third scenario 1003, latency_A denotes latency in the first scenario 1001, Latency_D denotes latency in the fourth scenario 1004, alpha denotes a margin value set by considering the failure of repetitive channel access, CW1* denotes a back-off counter that is reset according to the channel access failure of link 1, and CW2* denotes a back-off counter that is reset according to the channel access failure of link 2.

According to an embodiment, the failure of channel access may also include, in addition to the third scenario 1003 (e.g., link 1 fails one time) and the fourth scenario 1004 (e.g., link 2 fails one time), a case in which link 1 and/or link 2 fails channel access multiple times. However, this may be a minor value compared to other terms since the probability of repetitive channel access failure increases exponentially. The failure of repetitive channel access may be considered through the margin value, alpha, in Equation 9.

According to an embodiment, referring to Equation 5, the aggregation gain may be expressed as the product of the probability of channel access success of each link (e.g., link 1 and link 2) and the transmission time. The aggregation gain may be greater as the state of the channel is better (e.g., as the channel congestion is lower). The aggregation gain may be greater as the size of data (e.g., the size of a PPDU) transmitted through the links increases (e.g., as the transmission time is longer).

According to an embodiment, referring to Equation 9, it may be seen that the aggregation loss depends on the probability of channel access success of the links, CW1*, and CW2 *. CW1* and CW2* may be back-off counters that are reset according to the channel access failure of the links. CW1* and CW2* may be exponentially increased compared to the immediately previous back-off counter (e.g., CW1 and/or CW2) value. As the absolute value of the back-off counter (e.g., CW1 and/or CW2) increases, CW1* and CW2* may increase exponentially. The aggregation loss may be greater as the back-off counters of the links increase.

According to an embodiment, the trade-off relationship between the aggregation gain and the aggregation loss may be expressed as shown in Table 1.

TABLE 1

| Aggregation gain | Aggregation loss |
|---|---|
| Large PPDU Size | High back-off counter |
| Low congestion | High congestion |
| Low retry | Low retry |
| High RSSI | Low RSSI |

The non-AP MLD 801 may maximize and/or improve the efficiency and utilization of a multi-link by adaptively operating link aggregation based on the aggregation gain and the aggregation loss.

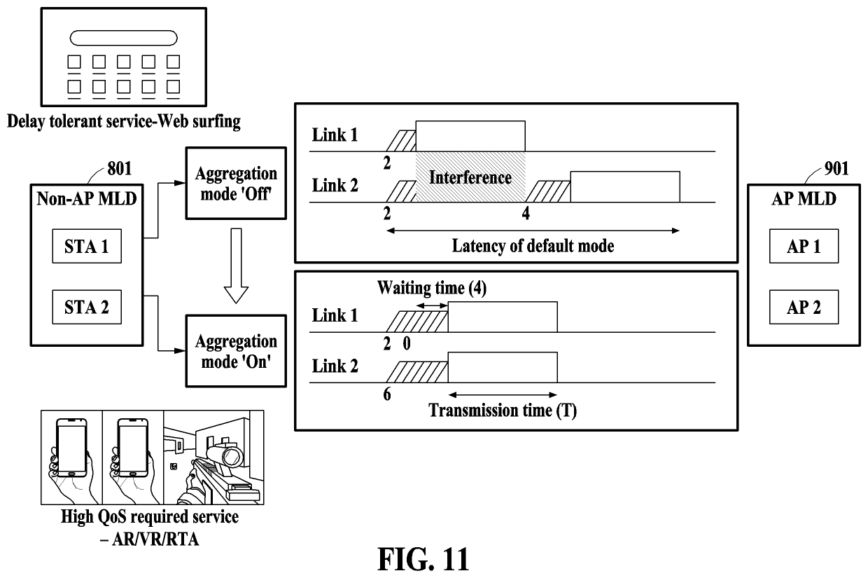

FIG. 11 is a diagram illustrating an example operation of triggering link aggregation based on the characteristics of pieces of data and the characteristics of channels, according to various embodiments.

Referring to FIG. 11, according to an embodiment, the non-AP MLD 801 may trigger link aggregation (e.g., link aggregation of link 1 and link 2) based on the characteristics of the pieces of data and the characteristics of the channels. The non-AP MLD 801 may adaptively operate link aggregation by detecting situations requiring link aggregation based on the characteristics of the pieces of data and the channels. The non-AP MLD 801 may also adaptively operate link aggregation without calculating aggregation gain and/or aggregation loss.

According to an embodiment, the characteristics of the channels may include channel congestion (e.g., channel congestion based on a probability of channel access success). Channel congestion may be based on the probability of channel access success calculated through Equations 6 and 7. Channel congestion may change depending on the number of terminals connected to an AP (e.g., the AP MLD 901 of FIG. 11) and/or the number of terminals using Wi-Fi around a terminal (e.g., the non-AP MLD 801 of FIG. 9) of a current user. The non-AP MLD 801 may monitor the characteristics of the pieces of data when channel congestion is low (e.g., when the probability of channel access success is high).

According to an embodiment, when channel congestion is low, the non-AP MLD 801 may trigger link aggregation to satisfy the QoS requirements of a service by monitoring the characteristics of the pieces of data. The non-AP MLD 801 may trigger link aggregation by detecting a service (e.g., an augmented-reality (AR) service, a virtual-reality (VR) service, or a real-time game service) requiring high QoS. The non-AP MLD 801 may not trigger link aggregation when a service requiring low QoS (e.g., web surfing) is detected.

According to an embodiment, the non-AP MLD 801 may utilize information of an access category, which specifies the priority of traffic, as the characteristics of the pieces of data. The access category may be classified into four categories (e.g., AC_VO, AC_VI, AC_BE, and AC_BK). AC_VO may correspond to the highest priority packet, and AC_BK may correspond to the lowest priority packet (e.g., background data). The non-AP MLD 801 may detect whether a service to be executed in the non-AP MLD 801 requires high QoS based on the access category. For example, when the access category corresponds to AC_VO or AC_VI, the non-AP MLD 801 may determine that the service to be executed in the non-AP MLD 801 requires high QoS.

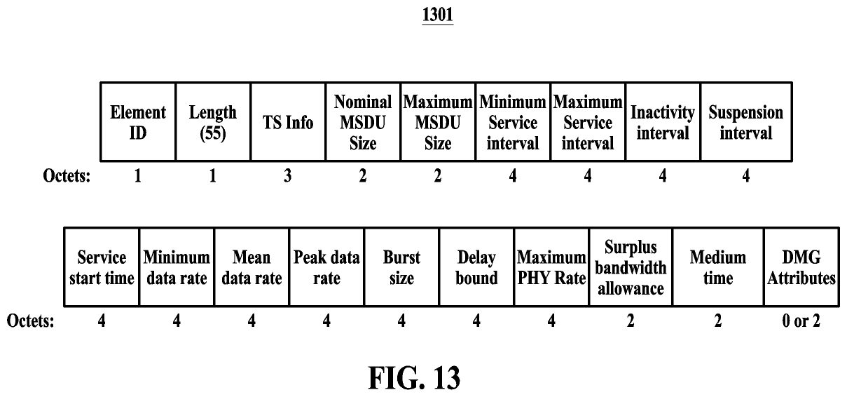

According to an embodiment, the non-AP MLD 801 may utilize a TSPEC element, which is used in a TSPEC negotiation, as the characteristics of the pieces of data. The TSPEC element may specify QoS-related information (e.g., a mean data rate, a delay bound, and/or a service interval) of the service to be executed in the non-AP MLD 801. The TSPEC element is described in detail with reference to FIG. 13. The non-AP MLD 801 may detect whether the service to be executed in the non-AP MLD 801 requires high QoS based on the TSPEC element.

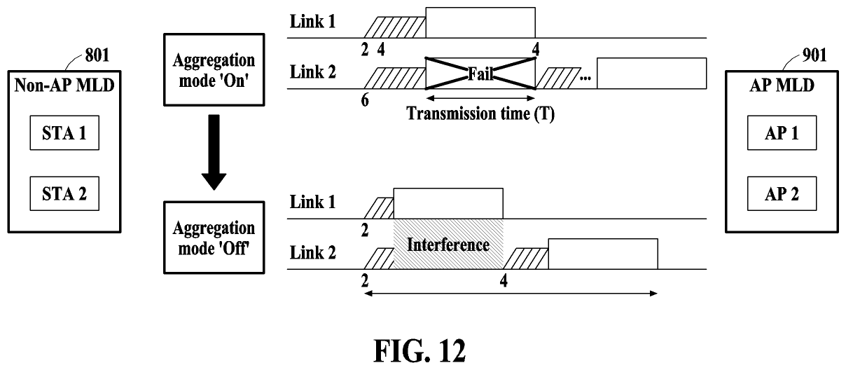

FIG. 12 is a diagram illustrating an example operation of selectively terminating link aggregation according to various embodiments, and FIG. 13 is a diagram illustrating a TSPEC element according to various embodiments.

Referring to FIG. 12, according to an embodiment, the non-AP MLD 801 may selectively terminate link aggregation of aggregated links (e.g., link 1 and link 2) based on the characteristics of pieces of data and the characteristics of channels. By appropriately terminating link aggregation in an activated state, the non-AP MLD 801 may reduce wasted time (e.g., latency) and utilize radio resources efficiently while preventing/reducing IDC interference.

According to an embodiment, the characteristics of the channels may include the number of channel access failures of the aggregated links. The non-AP MLD 801 may terminate link aggregation of the aggregated links by detecting the number of channel access failures that is greater than a threshold value.

According to an embodiment, the characteristics of the channels may include channel congestion (e.g., channel congestion based on a probability of channel access success). Channel congestion may be based on the probability of channel access success calculated through Equations 6 and 7. The non-AP MLD 801 may monitor channel congestion of the aggregated links and may terminate link aggregation when channel congestion increases (e.g., when the probability of channel access success decreases).

According to an embodiment, the characteristics of the pieces of data may include an access category that specifies the priority of traffic. The non-AP MLD 801 may monitor the priority of the pieces of data to be transmitted through the aggregated links. The non-AP MLD 801 may selectively terminate link aggregation of the aggregated links by detecting (e.g., detecting a decrease in priority) a change in priority of the pieces of data to be transmitted through the aggregated links.

According to an embodiment, the characteristics of the pieces of data may include QoS requirements of a service executed through the non-AP MLD 801. The non-AP MLD 801 may monitor the QoS requirements of the service executed through the non-AP MLD 801. The non-AP MLD 801 may maintain link aggregation when the QoS requirements of the service are satisfied through the aggregated links. The QoS requirements may be obtained from a TSPEC element used in a TSPEC negotiation.

Referring to FIG. 13, according to an embodiment, a TSPEC element 1301 defined in the IEEE 802.11 may be identified. The TSPEC element 1301 may include the fields of Element ID, Length, traffic stream information (TS Info), Nominal MAC service data unit (MSDU) Size, Maximum MSDU Size, Minimum Service interval, Maximum Service interval, Inactivity interval, and Suspension interval. The TSPEC element 1301 may include the fields of Service start time, Minimum data rate, Mean data rate, Peak data rate, Minimum physical layer (PHY) Rate, Surplus bandwidth allowance, Medium time, directional multi-gigabit (DMG) Attributes, or Delay bound.

According to an embodiment, the field of Element ID may indicate the type of element (e.g., a TSPEC element). The field of Length may indicate the length of a TSPEC element. The field of TS Info may provide traffic stream information. The field of Nominal MSDU Size may indicate a variable length of a nominal MSDU or a nominal A-MSDU belonging to a TS. The field of Maximum MSDU Size may indicate the maximum size of an MSDU or an A-MSDU. The field of Minimum Service interval may indicate the minimum time between the start times of two consecutive service periods (SPs). The field of Maximum Service interval may indicate the maximum time between the start times of two consecutive SPs. The field of Inactivity interval may indicate the maximum time interval before the transmission arrival of an MSDU belonging to a TS. The field of Suspension interval may indicate the maximum time interval during which there is no arrival or transmission of an MSDU belonging to a corresponding TS until the generation of consecutive QoS(+)CF-Poll for the corresponding TS is stopped.

According to an embodiment, the field of Service start time may indicate a start time of a first SP. The field of Minimum data rate may indicate the lowest data transmission rate specified by a MAC SAP to transmit an MSDU or an A-MSDU belonging to a TS. The field of Mean data rate may indicate a mean data transmission rate specified by a MAC SAP to transmit an MSDU or an A-MSDU belonging to a TS. The field of Peak data rate may indicate the maximum data transmission rate specified by a MAC SAP to transmit an MSDU or an A-MSDU belonging to a TS. The field of Burst size may indicate the maximum burst of an MSDU or an A-MSDU belonging to a TS at the peak data transmission rate. The field of Delay bound may be the maximum time during which an MSDU or an A-MSDU belonging to a TS may be transmitted. The field of Minimum PHY Rate may indicate the lowest PHY rate at which an MSDU or an A-MSDU belonging to a TS may be transmitted. The field of Medium time may indicate a time allowed for media access. The field of DMG Attributes may be displayed when TSPEC is applied to a DMG BSS.

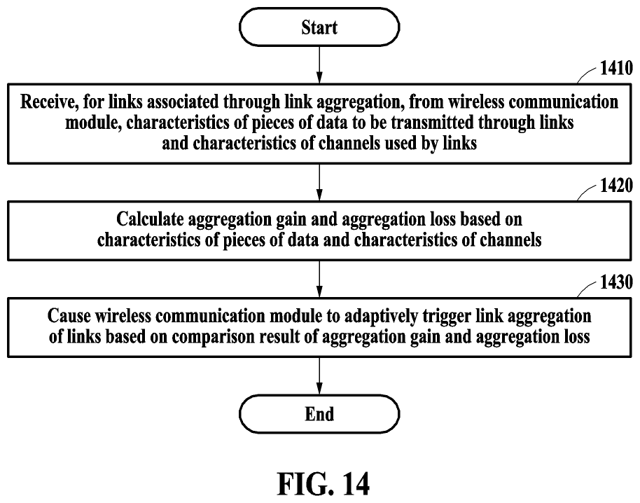

FIGS. 14, 15 and 16 are flowcharts illustrating example methods of operating an electronic device, according to various embodiments.

Referring to FIG. 14, according to an embodiment, operations 1410 to 1430 may be performed sequentially but not necessarily. For example, the order of operations 1410 to 1430 may be changed, and at least two of operations 1410 to 1430 may be performed in parallel.

According to an embodiment, in operation 1410, a processor (e.g., the processor 820 of FIG. 8 or a processor 1720 of FIG. 17) may receive, for links associated through link aggregation, from a wireless communication module (e.g., the wireless communication module 810 of FIG. 8 or a wireless communication module 1792 of FIG. 17), the characteristics of pieces of data (e.g., the sizes of pieces of data) to be transmitted through the links and the characteristics of channels (e.g., a probability of channel access success) used by the links.

According to an embodiment, in operation 1420, the processor 820 may calculate aggregation gain and aggregation loss based on the characteristics of the pieces of data and the characteristics of the channels. The aggregation gain and the aggregation loss may be calculated based on latency that changes depending on the channel access success or failure.

According to an embodiment, in operation 1430, the processor 820 may cause the wireless communication module 810 to adaptively trigger link aggregation of the links based on the comparison result of the aggregation gain and the aggregation loss. Link aggregation may include synchronizing at least one of the data transmission start time and/or the data transmission end time of the aggregated links in an NSTR mode.

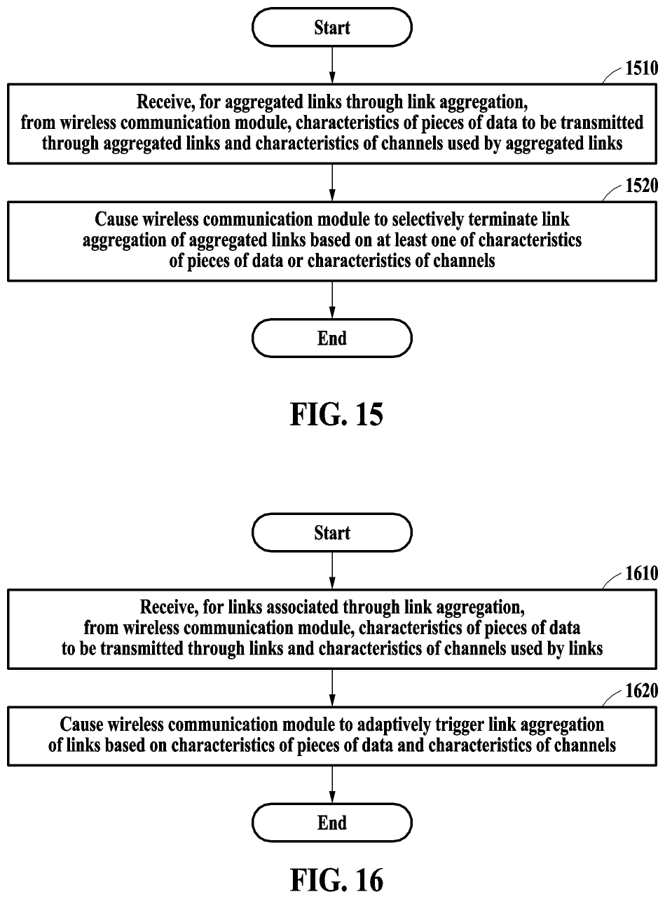

Referring to FIG. 15, according to an embodiment, operations 1510 and 1520 may be performed sequentially but not necessarily. For example, the order of operations 1510 and 1520 may be changed, and at least two of operations 1510 and 1520 may be performed in parallel.

According to an embodiment, in operation 1510, a processor (e.g., the processor 820 of FIG. 8 or a processor 1720 of FIG. 17) may receive, for aggregated links through link aggregation, from a wireless communication module (e.g., the wireless communication module 810 of FIG. 8 or a wireless communication module 1792 of FIG. 17), the characteristics of pieces of data to be transmitted through the aggregated links (e.g., QoS requirements of a service executed through an electronic device (e.g., the electronic device 801 of FIG. 8 or an electronic device 1701 of FIG. 17) including a processor and/or access category information specifying the priority of traffic)) and the characteristics of channels used by the aggregated links (e.g., channel congestion based on a probability of channel access success and/or the number of channel access failures of the aggregated links).

According to an embodiment, in operation 1520, the processor 820 may cause the wireless communication module 810 to selectively terminate link aggregation of the aggregated links based on at least one of the characteristics of the pieces of data or the characteristics of the channels.

Referring to FIG. 16, according to an embodiment, operations 1610 and 1620 may be performed sequentially but not necessarily. For example, the order of operations 1610 and 1620 may be changed, and at least two of operations 1610 and 1620 may be performed in parallel.

According to an embodiment, in operation 1610, a processor (e.g., the processor 820 of FIG. 8 or a processor 1720 of FIG. 17) may receive, for links associated through link aggregation, from a wireless communication module (e.g., the wireless communication module 810 of FIG. 8 or a wireless communication module 1792 of FIG. 17), the characteristics of pieces of data to be transmitted through the links and the characteristics of channels used by the links.

According to an embodiment, in operation 1620, the processor 820 may cause the wireless communication module 810 to adaptively trigger link aggregation of the links based on the characteristics of the pieces of data and the characteristics of the channels. The characteristics of the pieces of data may include QoS requirements of a service executed through an electronic device (e.g., the electronic device 401 of FIG. 4, the electronic device 801 of FIG. 8, or an electronic device 1701 of FIG. 17), which are obtained based on a TSPEC element.

FIG. 17 is a block diagram illustrating an example electronic device in a network environment, according to various embodiments.

Referring to FIG. 17, an electronic device 1701 in a network environment 1700 may communicate with an electronic device 1702 via a first network 1798 (e.g., a short-range wireless communication network), or communicate with at least one of an electronic device 1704 and a server 1708 via a second network 1799 (e.g., a long-range wireless communication network). According to an embodiment, the electronic device 1701 may communicate with the electronic device 1704 via the server 1708. According to an embodiment, the electronic device 1701 may include a processor 1720, memory 1730, an input module 1750, a sound output module 1755, a display module 1760, an audio module 1770, a sensor module 1776, an interface 1777, a connecting terminal 1778, a haptic module 1779, a camera module 1780, a power management module 1788, a battery 1789, a communication module 1790, a subscriber identity module (SIM) 1796, or an antenna module 1797. In an embodiment, at least one of the components (e.g., the connecting terminal 1778) may be omitted from the electronic device 1701, or one or more other components may be added to the electronic device 1701. In an embodiment, some of the components (e.g., the sensor module 1776, the camera module 1780, or the antenna module 1797) may be integrated as a single component (e.g., the display module 1760).

The processor 1720 may execute, for example, software (e.g., a program 1740) to control at least one other component (e.g., a hardware or software component) of the electronic device 1701 connected to the processor 1720, and may perform various data processing or computation. According to an embodiment, as at least a part of data processing or computation, the processor 1720 may store a command or data received from another component (e.g., the sensor module 1776 or the communication module 1790) in a volatile memory 1732, process the command or the data stored in the volatile memory 1732, and store resulting data in a non-volatile memory 1734. According to an embodiment, the processor 1720 may include the main processor 1721 (e.g., a CPU or an AP), or an auxiliary processor 1723 (e.g., a GPU, a neural processing unit (NPU), an ISP, a sensor hub processor, or a CP) that is operable independently from, or in conjunction with the main processor 1721. For example, when the electronic device 1701 includes the main processor 1721 and the auxiliary processor 1723, the auxiliary processor 1723 may be adapted to consume less power than the main processor 1721 or to be specific to a specified function. The auxiliary processor 1723 may be implemented separately from the main processor 1721 or as a part of the main processor 1721. Thus, the processor 1720 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 1723 may control at least some of functions or states related to at least one (e.g., the display module 1760, the sensor module 1776, or the communication module 1790) of the components of the electronic device 1701, instead of the main processor 1721 while the main processor 1721 is in an inactive (e.g., sleep) state or together with the main processor 1721 while the main processor 1721 is in an active state (e.g., executing an application). According to an embodiment, the auxiliary processor 1723 (e.g., an ISP or a CP) may be implemented as a portion of another component (e.g., the camera module 1780 or the communication module 1790) that is functionally related to the auxiliary processor 1723. According to an embodiment, the auxiliary processor 1723 (e.g., an NPU) may include a hardware structure specifically for artificial intelligence (AI) model processing. An AI model may be generated by machine learning. Such learning may be performed by, for example, the electronic device 1701 in which the AI model is performed or performed via a separate server (e.g., the server 1708). A learning algorithm may include, but is not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto.). The AI model may additionally or alternatively include a software structure other than the hardware structure.

The memory 1730 may store various pieces of data used by at least one component (e.g., the processor 1720 or the sensor module 1776) of the electronic device 1701. The various pieces of data may include, for example, software (e.g., the program 1740) and input data or output data for a command related thereto. The memory 1730 may include the volatile memory 1732 or the non-volatile memory 1734.

The program 1740 may be stored as software in the memory 1730, and may include, for example, an operating system (OS) 1742, middleware 1744, or an application 1746.

The input module 1750 may receive, from the outside (e.g., a user) of the electronic device 1701, a command or data to be used by a component (e.g., the processor 1720) of the electronic device 1701. The input module 1750 may include, for example, a microphone, a mouse, a keyboard, a key (e.g., a button), or a digital pen (e.g., a stylus pen).

The sound output module 1755 may output a sound signal to the outside of the electronic device 1701. The sound output module 1755 may include, for example, a speaker or receiver. The speaker may be used for general purposes, such as playing multimedia or playing record. The receiver may be used to receive an incoming call. According to an embodiment, the receiver may be implemented separately from the speaker or as a portion of the speaker.

The display module 1760 may visually provide information to the outside (e.g., a user) of the electronic device 1701. The display module 1760 may include, for example, a display, a hologram device, or a projector and control circuitry to control a corresponding one of the display, the hologram device, and the projector. According to an embodiment, the display module 1760 may include a touch sensor adapted to sense a touch or a pressure sensor adapted to measure an intensity of a force incurred by the touch.

The audio module 1770 may convert a sound into an electric signal and vice versa. According to an embodiment, the audio module 1770 may obtain the sound via the input module 1750 or output the sound via the sound output module 1755 or an external electronic device (e.g., the electronic device 1702 such as a speaker or headphones) directly or wirelessly connected to the electronic device 1701.

The sensor module 1776 may detect an operational state (e.g., power or temperature) of the electronic device 1701 or an environmental state (e.g., a state of a user) external to the electronic device 1701 and generate an electrical signal or data value corresponding to the detected state. According to an embodiment, the sensor module 1776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1777 may support one or more specified protocols to be used for the electronic device 1701 to be coupled with the external electronic device (e.g., the electronic device 1702) directly or wirelessly. According to an embodiment, the interface 1777 may include, for example, a high definition multimedia interface (HDMI), a universal serial bus (USB) interface, a secure digital (SD) card interface, or an audio interface.

The connecting terminal 1778 may include a connector via which the electronic device 1701 may be physically connected to an external electronic device (e.g., the electronic device 1702). According to an embodiment, the connecting terminal 1778 may include, for example, an HDMI connector, a USB connector, an SD card connector, or an audio connector (e.g., a headphone connector).

The haptic module 1779 may convert an electrical signal into a mechanical stimulus (e.g., a vibration or a movement) or an electrical stimulus which may be recognized by a user via his or her tactile sensation or kinesthetic sensation. According to an embodiment, the haptic module 1779 may include, for example, a motor, a piezoelectric element, or an electric stimulator.

The camera module 1780 may capture a still image and moving images. According to an embodiment, the camera module 1780 may include one or more lenses, image sensors, ISPs, or flashes.

The power management module 1788 may manage power supplied to the electronic device 1701. According to an embodiment, the power management module 1788 may be implemented as, for example, at least a part of a power management integrated circuit (PMIC).

The battery 1789 may supply power to at least one component of the electronic device 1701. According to an embodiment, the battery 1789 may include, for example, a primary cell which is not rechargeable, a secondary cell which is rechargeable, or a fuel cell.

The communication module 1790 may support establishing a direct (e.g., wired) communication channel or a wireless communication channel between the electronic device 1701 and the external electronic device (e.g., the electronic device 1702, the electronic device 1704, or the server 1708) and performing communication via the established communication channel. The communication module 1790 may include one or more communication processors that operate independently of the processor 1720 (e.g., an application processor) and support direct (e.g., wired) communication or wireless communication. According to an embodiment, the communication module 1790 may include a wireless communication module 1792 (e.g., a cellular communication module, a short-range wireless communication module, or a global navigation satellite system (GNSS) communication module) or a wired communication module 1794 (e.g., a local area network (LAN) communication module, or a power line communication (PLC) module). A corresponding one of these communication modules may communicate with the external electronic device 1704 via the first network 1798 (e.g., a short-range communication network, such as Bluetooth™, Wi-Fi Direct, or infrared data association (IrDA)) or the second network 1799 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip) or may be implemented as a plurality of components (e.g., a plurality of chips) separate from each other. The wireless communication module 1792 may identify and authenticate the electronic device 1701 in a communication network, such as the first network 1798 or the second network 1799, using subscriber information (e.g., international mobile subscriber identity (IMSI)) stored in the SIM 1796.

The wireless communication module 1792 may support a 5G network after a 4G network, and next-generation communication technology, for example, new radio (NR) access technology. The NR access technology may support enhanced mobile broadband (eMBB), massive machine type communications (mMTC), or ultra-reliable and low-latency communications (URLLC). The wireless communication module 1792 may support a high-frequency band (e.g., a millimeter wave (mm Wave) band) to achieve, e.g., a high data transmission rate. The wireless communication module 1792 may support various technologies for securing performance on a high-frequency band, such as, beamforming, massive multiple-input and multiple-output (MIMO), full dimensional MIMO (FD-MIMO), an array antenna, analog beam-forming, or a large scale antenna. The wireless communication module 1792 may support various requirements specified in the electronic device 1701, an external electronic device (e.g., the electronic device 1704), or a network system (e.g., the second network 1799). According to an embodiment, the wireless communication module 1792 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 1797 may transmit or receive a signal or power to or from the outside (e.g., an external electronic device) of the electronic device. According to an embodiment, the antenna module 1797 may include an antenna including a radiating element including a conductive material or a conductive pattern formed in or on a substrate (e.g., a printed circuit board (PCB)). According to an embodiment, the antenna module 1797 may include a plurality of antennas (e.g., array antennas). In such a case, at least one antenna appropriate for a communication scheme used in a communication network, such as the first network 1798 or the second network 1799, may be selected by, for example, the communication module 1790 from the plurality of antennas. The signal or power may be transmitted or received between the communication module 1790 and the external electronic device via the at least one selected antenna. According to an embodiment, another component (e.g., a radio frequency integrated circuit (RFIC)) other than the radiating element may be additionally formed as a part of the antenna module 1797.

According to an embodiment, the antenna module 1797 may form a mm Wave antenna module. According to an embodiment, the mmWave antenna module may include a PCB, an RFIC disposed on a first surface (e.g., the bottom surface) of the PCB or adjacent to the first surface and capable of supporting a designated high-frequency band (e.g., the mm Wave band), and a plurality of antennas (e.g., array antennas) disposed on a second surface (e.g., the top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1701 and the external electronic device 1704 via the server 1708 coupled with the second network 1799. Each of the external electronic devices 1702 or 1704 may be a device of the same type as or a different type from the electronic device 1701. According to an embodiment, all or some of operations to be executed by the electronic device 1701 may be executed at one or more external electronic devices (e.g., the external electronic devices 1702 and 1704, and the server 1708). For example, if the electronic device 1701 needs to perform a function or a service automatically, or in response to a request from a user or another device, the electronic device 1701, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 1701. The electronic device 1701 may provide the outcome, with or without further processing of the outcome, as at least part of a reply to the request. To that end, a cloud computing, distributed computing, mobile edge computing (MEC), or client-server computing technology may be used, for example. The electronic device 1701 may provide ultra low-latency services using, e.g., distributed computing or MEC. In an embodiment, the external electronic device 1704 may include an Internet-of-things (IoT) device. The server 1708 may be an intelligent server using machine learning and/or a neural network. According to an embodiment, the external electronic device 1704 or the server 1708 may be included in the second network 1799. The electronic device 1701 may be applied to intelligent services (e.g., a smart home, a smart city, a smart car, or healthcare) based on 5G communication technology or IoT-related technology.

The electronic device according to an embodiment may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various example embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms such as “1st,” and “2nd,” or “first” and “second” may be used to simply distinguish a corresponding component from another, and do not limit the components in other aspect (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., wiredly), wirelessly, or via a third component.

As used in connection with embodiments of the disclosure, the term “module” may include a unit implemented in hardware, software, or firmware, or any combination thereof, and may interchangeably be used with other terms, for example, “logic”, “logic block”, “part”, or “circuitry”. A module may be a single integral component, or a minimum unit or part thereof, adapted to perform one or more functions. For example, according to an example, the module may be implemented in a form of an application-specific integrated circuit (ASIC).

Embodiments as set forth herein may be implemented as software (e.g., the program 1740) including one or more instructions that are stored in a storage medium (e.g., an internal memory 1736 or an external memory 1738) that is readable by a machine (e.g., the electronic device 1701). For example, a processor (e.g., the processor 1720) of the nearby device (e.g., the electronic device 1701) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server. According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

An electronic device (e.g., the non-AP MLD (401) of FIG. 4, the non-AP MLD (801) of FIG. 8, and the electronic device (1701) of FIG. 17) according to an embodiment may include one or more wireless communication modules (e.g., the wireless communication module (810) of FIG. 8 and the wireless communication module (1792) of FIG. 17) configured to transmit and receive a wireless signal, one or more processors (e.g., the processor (820) of FIG. 8 and the processor (1720) of FIG. 17) operatively connected to the wireless communication module (810), and a memory (e.g., the memory (830) of FIG. 8 and the memory (1730) of FIG. 17) storing instructions. The instructions, when executed by the one or more processors (820, 1720) individually or collectively, may cause the electronic device (401; 801; 1701) to receive, for links associated through link aggregation, from the wireless communication module (810), characteristics of pieces of data to be transmitted through the links and characteristics of channels used by the links. The instructions, when executed by the one or more processors (820, 1720) individually or collectively, may cause the electronic device (401; 801; 1701) to calculate aggregation gain and aggregation loss based on the characteristics of the pieces of data and the characteristics of the channels. The instructions, when executed by the one or more processors (820, 1720) individually or collectively, may cause the electronic device (401; 801; 1701) to cause the wireless communication module (810) to adaptively trigger link aggregation of the links based on the comparison result of the aggregation gain and the aggregation loss.

According to an embodiment, the link aggregation may include the electronic device (801), which is a non-AP MLD, synchronizing at least one of the data transmission start time and/or data transmission end time of aggregated links in an NSTR mode.

According to an embodiment, each of the pieces of data to be transmitted through the links may be scheduled in advance so that a transmission time is the same.

According to an embodiment, the characteristics of the pieces of data may include the sizes of the pieces of data.

According to an embodiment, the characteristics of the channels may include a probability of channel access success of the links.

According to an embodiment, the probability of channel access success may be calculated based on channel information that is obtainable from an AOSP of the electronic device (801) or a CU value.

According to an embodiment, the aggregation gain and the aggregation loss may be calculated based on latency that changes depending on the channel access success or failure of the links.

According to an embodiment, the aggregation gain may be calculated based on the probability of channel access success of the links and latency when the links succeed in channel access at one time in a state in which link aggregation is activated.

According to an embodiment, the aggregation loss may be calculated based on the probability of channel access success of the links and latency when the links fail in channel access at least one time in a state in which the link aggregation is activated.

According to an embodiment, the instructions, when executed by the one or more processors (820, 1720) individually or collectively, may cause the electronic device (401; 801; 1701) to trigger the link aggregation when the aggregation gain is greater than the aggregation loss.

According to an embodiment, an electronic device (e.g., the non-AP MLD (401) of FIG. 4, the non-AP MLD (801) of FIG. 8, and the electronic device (1701) of FIG. 17) may include one or more wireless communication modules (e.g., the wireless communication module (810) of FIG. 8 and the wireless communication module (1792) of FIG. 17) configured to transmit and receive a wireless signal, one or more processors (e.g., the processor (820) of FIG. 8 and the processor (1720) of FIG. 17) operatively connected to the wireless communication module (810), and a memory (e.g., the memory (830) of FIG. 8 and the memory (1730) of FIG. 17) storing instructions. The instructions, when executed by the one or more processors (820, 1720) individually or collectively, may cause the electronic device (401; 801; 1701) to receive, for aggregated links through link aggregation, from the wireless communication modules, characteristics of pieces of data to be transmitted through the aggregated links and characteristics of channels used by the aggregated links. The instructions, when executed by the one or more processors (820, 1720) individually or collectively, may cause the electronic device (401; 801; 1701) to cause the wireless communication module (810) to selectively terminate link aggregation of the aggregated links based on at least one of the characteristics of the pieces of data or the characteristics of the channels.

According to an embodiment, the characteristics of the channels may include channel congestion based on a probability of channel access success of the links. The processor (820) may terminate the link aggregation of the aggregated links by detecting the channel congestion that is greater than a threshold value.

According to an embodiment, the characteristics of the channels may include the number of channel access failures of the aggregated links. The instructions, when executed by the one or more processors (820, 1720) individually or collectively, may cause the electronic device (401; 801; 1701) to terminate the link aggregation of the aggregated links by detecting the number of channel access failures that is greater than a threshold value.

According to an embodiment, the characteristics of the pieces of data may include QoS requirements of a service executed through the electronic device. The instructions, when executed by the one or more processors (820, 1720) individually or collectively, may cause the electronic device (401; 801; 1701) to maintain the link aggregation of the aggregated links when the QoS requirements of the service are satisfied through the aggregated links.

According to an embodiment, the QoS requirements may be obtained from a TSPEC element used in a TSPEC negotiation.

According to an embodiment, the characteristics of the pieces of data may include an access category that specifies the priority of traffic. The instructions, when executed by the one or more processors (820, 1720) individually or collectively, may cause the electronic device (401; 801; 1701) to selectively terminate the link aggregation of the aggregated links by detecting a change in priority of the pieces of data to be transmitted through the aggregated links.

According to an embodiment, an electronic device (e.g., the non-AP MLD (401) of FIG. 4, the non-AP MLD (801) of FIG. 8, and the electronic device (1701) of FIG. 17) may include one or more wireless communication modules (e.g., the wireless communication module (810) of FIG. 8 and the wireless communication module (1792) of FIG. 17) configured to transmit and receive a wireless signal, one or more processors (e.g., the processor (820) of FIG. 8 and the processor (1720) of FIG. 17) operatively connected to the wireless communication module (810), and a memory (e.g., the memory (830) of FIG. 8 and the memory (1730) of FIG. 17) storing instructions. The instructions, when executed by the one or more processors (820, 1720) individually or collectively, may cause the electronic device (401; 801; 1701) to receive, for links associated through link aggregation, from the wireless communication module (810), characteristics of pieces of data to be transmitted through the links and characteristics of channels used by the links. The instructions, when executed by the one or more processors (820, 1720) individually or collectively, may cause the electronic device (401; 801; 1701) to cause the wireless communication module (810) to adaptively trigger link aggregation of the links based on the characteristics of the pieces of data and the characteristics of the channels.

According to an embodiment, the characteristics of the pieces of data may include QoS requirements of a service executed through the electronic device (801), which are obtained based on a TSPEC element.

According to an embodiment, the characteristics of the channels may include channel congestion corresponding to a probability of channel access success of the links.

According to an embodiment, the instructions, when executed by the one or more processors (820, 1720) individually or collectively, may cause the electronic device (401; 801; 1701) to trigger link aggregation of the links to satisfy the QoS requirements of the service when the channel congestion is lower than a threshold value.

According to an embodiment, the channel congestion may be calculated based on channel information that is obtainable from an AOSP of the electronic device (801) or a CU value.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
one or more wireless communication modules comprising communication circuitry configured to transmit and/or receive a wireless signal;
at least one processor, comprising processing circuitry, operatively connected to the wireless communication modules; and
a memory including instructions,
wherein at least one processor, individually or collectively, is configured to execute the instructions and to cause the electronic device to:
for links associated through link aggregation, receive, from the wireless communication modules, characteristics of pieces of data to be transmitted through the links and characteristics of channels used by the links,
calculate aggregation gain and aggregation loss based on the characteristics of the pieces of data and the characteristics of the channels, and
cause the wireless communication modules to adaptively trigger link aggregation of the links based on a comparison result of the aggregation gain and the aggregation loss.

2. The electronic device of claim 1, wherein the link aggregation comprises the electronic device, comprising a non-access point (AP) multi-link device (MLD), synchronizing at least one of a data transmission start time and/or a data transmission end time of aggregated links in a non-simultaneous transmit and receive operation (NSTR) mode.

3. The electronic device of claim 1, wherein each of the pieces of data to be transmitted through the links is configured to be scheduled in advance so that a transmission time is the same.

4. The electronic device of claim 1, wherein the characteristics of the pieces of data comprise sizes of the pieces of data.

5. The electronic device of claim 1, wherein the characteristics of the channels comprise a probability of channel access success of the links.

6. The electronic device of claim 5, wherein the probability of channel access success is calculated based on channel information obtainable from an Android open-source project (AOSP) of the electronic device and/or a channel utilization (CU) value.

7. The electronic device of claim 1, wherein the aggregation gain and the aggregation loss are calculated based on latency that changes depending on success or failure of channel access of the links.

8. The electronic device of claim 1, wherein:
the aggregation gain is calculated based on the probability of channel access success of the links and latency based on the links succeeding in channel access at one time in a state in which link aggregation is activated, and
the aggregation loss is calculated based on the probability of channel access success of the links and latency based on the links failing in channel access at least one time in a state in which the link aggregation is activated.

9. The electronic device of claim 1, wherein at least one processor, individually or collectively, is configured to cause the electronic device to trigger the link aggregation based on the aggregation gain being greater than the aggregation loss.

10. An electronic device comprising:
one or more wireless communication modules comprising communication circuitry configured to transmit and/or receive a wireless signal;
at least one processor, comprising processing circuitry, operatively connected to the wireless communication modules; and
a memory including instructions,
wherein at least one processor, individually or collectively, is configured to execute the instructions and to cause the electronic device to:
for aggregated links through link aggregation, receive, from the wireless communication modules, characteristics of pieces of data to be transmitted through the aggregated links and characteristics of channels used by the aggregated links, and
cause the wireless communication modules to selectively terminate link aggregation of the aggregated links based on at least one of the characteristics of the pieces of data or the characteristics of the channels.

11. The electronic device of claim 10, wherein:
the characteristics of the channels comprise channel congestion based on a probability of channel access success of the links,
at least one processor, individually or collectively, is configured to terminate the link aggregation of the aggregated links by detecting the channel congestion that is greater than a threshold value.

12. The electronic device of claim 10, wherein the characteristics of the channels comprise a number of channel access failures of the aggregated links, and
wherein at least one processor, individually or collectively, is configured to cause the electronic device to terminate the link aggregation of the aggregated links by detecting the number of channel access failures that is greater than a threshold value.

13. The electronic device of claim 10, wherein the characteristics of the pieces of data comprise quality of service (QoS) requirements of a service executed through the electronic device (, and
wherein at least one processor, individually or collectively, is configured to cause the electronic device to maintain the link aggregation of the aggregated links based on the QOS requirements of the service being satisfied through the aggregated links.

14. The electronic device of claim 13, wherein the QoS requirements are obtained from a traffic specification (TSPEC) element used in a TSPEC negotiation.

15. The electronic device of claim 10, wherein the characteristics of the pieces of data comprise an access category that specifies a priority of traffic, and
wherein at least one processor, individually or collectively, is configured to cause the electronic device to selectively terminate the link aggregation of the aggregated links by detecting a change in priority of the pieces of data to be transmitted through the aggregated links.

16. A method performed by an electronic device, the method comprising:
for links associated through link aggregation, receiving, characteristics of pieces of data to be transmitted through the links and characteristics of channels used by the links,
calculating aggregation gain and aggregation loss based on the characteristics of the pieces of data and the characteristics of the channels, and
adaptively triggering link aggregation of the links based on a comparison result of the aggregation gain and the aggregation loss.

17. The method of claim 16, wherein the link aggregation comprises the electronic device, comprising a non-access point (AP) multi-link device (MLD), synchronizing at least one of a data transmission start time and/or a data transmission end time of aggregated links in a non-simultaneous transmit and receive operation (NSTR) mode.

18. The method of claim 16, wherein the aggregation gain is calculated based on the probability of channel access success of the links and latency based on the links succeeding in channel access at one time in a state in which link aggregation is activated.

19. The method of claim 16, wherein the aggregation loss is calculated based on the probability of channel access success of the links and latency based on the links failing in channel access at least one time in a state in which the link aggregation is activated.

20. The method of claim 16, wherein the adaptively triggering comprises triggering the link aggregation based on the aggregation gain being greater than the aggregation loss
